(19) United States
(12) Patent Application Publication
(10) Pub. No.: US 2005/0050750 A1
(43) Pub. Date: Mar. 10, 2005

(54) Footwear organizer, sanitizer, and deodorizer

(76) Inventor: William Scott Whiting, The Woodlands, TX (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 10/619,085

(22) Filed: Jul. 11, 2003

(51) Int. Cl. F26B 19/00

(52) U.S. Cl. 34/90

(57) ABSTRACT

A sanitizing footwear organizer is disclosed. The invention comprises a case having an exterior portion and an inner chamber; at least one conduit, having an open end, situated in the case, said case supporting an article of footwear thereon, wherein the open end of the at least one conduit is in gaseous communication with the inner chamber of the hollow case; and a sanitizer disposed within the inner chamber of the hollow case for release into the article of footwear through the open end of the at least one conduit. The sanitizing footwear organizer may include a supplementary sanitizing system.

### FIELD OF THE INVENTION

The present invention is directed toward an organizer for footwear, and in particular, toward a footwear organizer that sanitizes, deodorizes and removes moisture from footwear, when they are placed in or upon organizer.

### BACKGROUND OF THE INVENTION

Organizing footwear and keeping them sanitary and fresh smelling is essential to the maintenance of a tidy home. Oftentimes, footwear can be the most difficult article of clothing to organize, sanitize, and deodorize. Footwear is often worn for months or even years without being cleaned. Footwear being warm dark and moist can be an optimum breeding ground for bacteria, fungi, and mold. If these are left to grow they can cause odors, athletes foot, toenail fungus, and other problem growths. This combined with footwear being thrown under the bed or merely tossed into the closet spreads these odors and creates a disorganized collection of footwear. As a result, numerous products directed toward organizing, or deodorizing footwear have been introduced into the market.

The patent literature discloses a number or relevant patents directed to footwear organization and deodorizing. For example, U.S. Pat. No. 6,098,815 discloses a shoe organizer system. The shoe organizer has two frame members spaced laterally to provide an open space to receive footwear. A spacer with a channel running along each edge extends between the two frame members. Each of the frame elements also has crossbars spaced vertically from one another with footwear mounts to hold footwear with their soles and heels facing inwardly. Links are pivotally mounted at two ends of the frame members so that the frame members can be folded substantially flat for shipping or storage.

U.S. Pat. No. 6,565,805 is directed to a method for deodorizing shoes including providing an ozone generator with a case of oblong shape; placing the ozone generator in the case in a shoe; energizing the ozone generator with electric power to generate an electric corona; and passing an oxygen containing gas through the electric corona so as to generate ozone, thereby deodorizing the shoe.

U.S. Pat. No. 5,065,871 discloses a rotary shoe rack, comprising a post for mounting a plurality of ring-shaped rotary members respectively vertically separated from one another by a plurality of sockets permitting said ring-shaped rotary members to be respectively rotated with respect to said sockets. The right-shaped rotary members have each a plurality of supporting rods obliquely extending upward outward therefrom around a circle for mounting a footwear organizer, which supporting rods have each a chemical bag at the top with aromatics contained therein to expel odor smell from the footwear mounted thereon.

Additionally, U.S. Pat. No. 5,911,957 relates to an ozone generator comprised of a discharge means and a reflecting screen. The discharge means comprises a rough-surfaced dielectric element with central aperture and rectangular cross-section sandwiched between a first electrode and a second electrode. The first electrode is comprised of a plurality of helical windings that contact a plurality of flanges on the dielectric element and the second electrode is comprised of an electrically conductive coating which overlies the rough surface of the dielectric element. The first electrode is aligned with respect to the central aperture, dielectric element, and the second electrode such that a constant distance of separation between the electrodes is maintained along the entire length of the discharge means. The reflecting screen, joined to the discharge means by a plurality of mounting borganizerets, directs accumulated ozone away from the ozone generator and toward an intended site for treatment. The disclosed invention converts oxygen to ozone with great efficiency and, unexpectedly, the fusion of the second electrode with the surface of the dielectric element provides improved ozone recovery by rapidly dissipating heat generated by the discharge means.

U.S. Pat. No. 6,451,266 discloses a system which massages a user's feet and generates an electrokinetic airflow that contains safe amounts of ozone that can deodorize the user's feet or socks. The system includes an ion generator comprising a high voltage pulse generator whose output pulses are coupled between left and right first and second electrode arrays. Preferably the first electrode array includes first and second pointed electrodes, and the second electrode array includes annular-like electrodes having a central opening coaxial with the associated pointed electrode. Preferably the annular-like electrodes are formed from a single sheet of metal by extrusion or punching such that the surface of the annular-like electrodes is smooth and continuous through the opening and into a collar region through which the air flows. Particulate matter in the ambient air electrostatically adheres to the smooth continuous surface of the annular-like electrodes.

U.S. Pat. No. 5,282,324 is directed to a shoe that is efficiently ventilated by forcing a low volume of primary air through a plurality of throttle orifices at high velocity downstream of a passage formed in a sole. A low pressure area is created within the passage. A high volume of stale secondary air from the footwear interior is accelerated into the low pressure area. The secondary air is entrained by the primary air and together form a combined jet-like air stream that is forcefully ejected from the footwear.

U.S. Pat. No. 5,291,669 discloses a shoe preserver having a wicking portion and an absorbing portion retained within a flexible porous covering. The preserver is sized to substantially fill the volume defined by the interior of the footwear. A pair of preservers is interconnected by a flexible strap attached to the forward portion of the preserver such that upon insertion into the footwear, the footwear and preserver may be carried by the strap.

U.S. Pat. No. 5,732,485 discloses a foot and footwear deodorizer. The deodorizer includes a retainer with an opening defined by an edge. It further includes a means for securing the retainer to the interior of a shoe. A patch containing fragrance to mask foot and shoe odors is held in place within the retainer opening.

Finally, U.S. Pat. No. 3,979,786 discloses a combined shoe tree and shoe deodorizer. The shoe tree and deodorizer include a vertical hollow tube closed at its top end having a first hole in its side wall adjacent its top end and filled with gaseous deodorizer under pressure. A vertical hollow cylinder closed at its top end and open at its bottom end has a second hole in its side wall. The cylinder is vertically slidable up and down along the tube whereby the holes can be moved into and out of alignment. The deodorizer escapes from the tube to the outside through the holes when aligned and is otherwise confined within the tube. Spring means disposed within the cylinder between the top ends of cylinder and tube normally biases the cylinder in a position relative to the tube at which the second hole is out of alignment with and disposed above the first hole. When a shoe engages cylinder and tube with the cylinder disposed inside the toe, the weight of the shoe overcomes the normal bias and the cylinder is moved downward until the second hole is out of alignment with and disposed below the first hole.

These deodorizers are only temporarily masking odors. To remove these odors, their sources need to be destroyed. A sanitizing agent such as ozone is capable of oxidizing these sources and acts as a sanitizer/deodorizer. Ozone is the second most potent sanitizer known. Ozone does not cover up odors with perfumes. Instead, it actually destroys the odors, fungi, mold, and bacteria at the molecular level. The constant flow of air mixed with ozone accomplishes three objectives; (removes moisture, sanitizes, and deodorizes). Ozone kills existing bacteria, fungi, mold and helps prevent athlete's foot, toenail fungus, odors, and other problem growths.

There is also a need for a footwear organizer sanitizer deodorizer wherein additional sanitizing, deodorizing and fungicidal agents may be introduced into the footwear in order to sanitize and deodorize them.

### OBJECTS AND SUMMARY OF THE INVENTION

It is an object of the present invention to provide a footwear organizer sanitizer deodorizer where articles of footwear may be placed in or on the footwear organizer such that they may be subjected to an amount of sanitizer deodorizer according to a person's desire.

Another object of the present invention is to provide a footwear organizer sanitizer deodorizer wherein sanitizing and deodorizing agents such as ozone may be introduced into the footwear in a desired quantity in order to sanitize and deodorize them.

Another object of the present invention is to provide a structure that organizes and/or holds one or more pairs of footwear, such as shoes, athletic footwear and boots.

Another object of the present invention is to provide an organizing structure that has a removable floor stand. With this floor stand installed organizer can be used free standing on a horizontal surface. With out floor stand installed organizer could be hung on a wall or a door.

Another object of the present invention is to provide a means for producing ozone (an ozone generator) for use in a footwear organizer sanitizer deodorizer.

Another object of the present invention is to provide a system having a rheostat electrically connected to the ozone generator for adjusting the output or concentration of ozone.

Another object of the present invention is to provide a programmable timer processor that coordinates programmed functions and monitors input from users and or sensors for the purpose of controlling output and concentration of ozone, and or other sanitizing/deodorizing/fungicidal agents.

Another object of the present invention is to provide an organizer that incorporates one or more flow paths or conduits from the optional sanitizing/deodorizing/fungicidal agents and ozone source to footwear in or on the organizer. These conduits are of equal dimensions to facilitate equal flow. This flow can be initiated or stopped manually by a user and or flow at programmed time intervals.

Another object of the present invention is to provide an organizer having a fan, pressurized source or other means to circulate ozone and or optional sanitizing/deodorizing/fungicidal agents through flow paths or conduits to the footwear.

Another object of the present invention is to provide, a mechanical switch and/or a combination of sensors that detect a user placing footwear in or on the organizer may also initiate flow. For example a pressure sensor, ambient light sensor, moisture sensor, temp sensor, motion sensor, mechanical switch or combination of sensors could be incorporated into the organizer so when footwear is placed on or in organizer the switch and/or sensors detect the footwear. The switch and/or sensor then signals the programmable timer/processor to initiate or cease flow.

Another object of the present invention is to provide an organizer in which an ozone sensor or detector may be incorporated as a safety measure. It would measure ambient air outside organizer and signal processor to adjust or cease production of ozone if ambient levels became too high.

Therefore, in accordance with a first aspect of the present invention, a novel sanitizing deodorizing footwear organizer is provided. This novel sanitizing deodorizing footwear organizer includes a case, having an exterior portion and an inner chamber. At least one conduit or flow path, having an open end, is mounted on the exterior of the case for hanging, holding or supporting an article of footwear, wherein the open end of the at least one conduit is in gaseous communication with the inner chamber of the hollow case. A sanitizer, such as ozone, is disposed within the inner chamber of the hollow case for release into the article of footwear through the open end of the at least one conduit. If more than one flow path or conduit exist, they need to be of equal dimensions to facilitate equal flow. A programmable timer/processor is incorporated to initiate flow of sanitizers, deodorizers, and fungicidal agents at programmed time intervals.

In accordance with another aspect of the present invention, a novel sanitizing deodorizing footwear organizer is provided for sanitizing and deodorizing a plurality of footwear. The novel sanitizing deodorizing footwear organizer includes a hollow case, having an exterior portion and an inner chamber. A plurality of equally dimensioned conduits, each having an open end, are mounted on the case for supporting a plurality of articles of footwear on, wherein the open ends of the plurality of equally dimensioned conduits are in gaseous communication with the inner chamber of the case.

A sanitizer/deodorizer, such as ozone, is disposed within the inner chamber of the hollow case for release into the articles of footwear through the open ends of the plurality of conduits. An air inlet is disposed on the exterior portion of the hollow case, and a compressor is disposed within the inner chamber of the hollow case proximate to the air inlet. A generator is disposed within the inner chamber of the hollow case, for generating the ozone. A rheostat in electrical communication with the programmable timer/processor and generator for adjusting the output or concentration of the ozone is provided. A programmable timer/processor is used for initiating flow of sanitizers, deodorizers, and fungicidal agents at programmed time intervals. A button is disposed on the exterior portion of the hollow case for manually starting the flow of sanitizers, deodorizers, and fungicidal agents. A removable floor stand is mounted on opposite ends of the exterior portion of the hollow case, or its exterior. Without this floor stand the footwear organizer sanitizer deodorizer could be hung on a wall or a door.

In accordance with another aspect of the present invention, a novel sanitizing deodorizing footwear organizer is provided for sanitizing and deodorizing a plurality of footwear with an optional source of sanitizing, deodorizing, or fungicidal agents. The novel sanitizing deodorizing footwear organizer includes a hollow case, having an exterior portion and an inner chamber. A plurality of equally dimensioned conduits, each having an open end, are mounted on the exterior of the hollow case for hanging a plurality of articles of footwear on, wherein the open ends of the plurality of conduits are in gaseous communication with the inner chamber of the hollow case. A sanitizer is disposed within the inner chamber of the hollow case for release into the articles of footwear through the open ends of the plurality of conduits. A programmable timer/processor is in electrical communication with the ozone generator and the rheostat. A floor stand may be mounted on opposite ends of the exterior portion of the hollow case. An air inlet is disposed on the exterior portion of the hollow case, and a compressor is disposed within the inner chamber of the hollow case proximate to the inlet. A removable floor stand may be mounted to the exterior portion of the hollow case. A programmable timer/processor is in electrical communication with the rheostat and the ozone generator. A generator is disposed within the inner chamber of the hollow case, for generating the sanitizer. A rheostat in electrical communication with the programmable timer/processor and generator for adjusting the output or concentration of the sanitizer is provided. A button is disposed on the exterior portion of the hollow case for manually starting the flow of sanitizers, deodorizers, and fungicidal agents. An optional pressurized source of sanitizing deodorizing, or fungicidal agents could be provided in gaseous communication with the inner chamber of the hollow case. A removable floor stand may be mounted to the exterior portion of the hollow case.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a side elevation in cross section of a footwear organizer sanitizer deodorizer in accordance with the present invention.

FIG. 2 is a front elevation of a footwear organizer sanitizer deodorizer.

FIG. 3 is a side elevation in cross section of a footwear organizer sanitizer deodorizer in accordance with an alternative embodiment of the present invention.

FIG. 4 and FIG. 5 are alternative embodiments of the present invention.

FIG. 6 is a third embodiment of the present invention.

### DETAILED DESCRIPTION OF THE PREFERRED EMBODIMENT

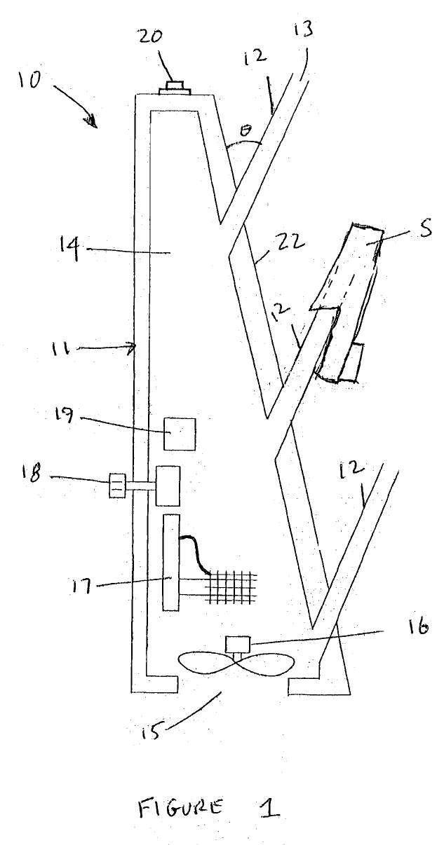

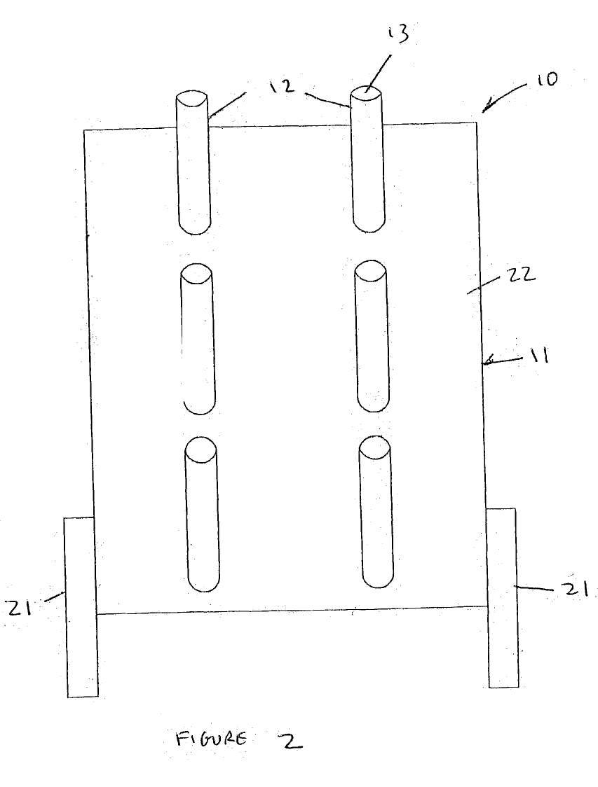

Referring now to the drawings, wherein like reference numerals refer to the same components across the several views, and in particular to FIGS. 1 and 2, there is shown a footwear organizer sanitizer deodorizer 10. The footwear organizer sanitizer deodorizer 10 includes a case 11, conduits or flow paths 12, and one or more floor stands 21. While the present invention is shown in the context of a plurality of equally dimensioned conduits or flow paths such as hollow posts, it is to be noted that any conduit is applicable to the teachings of the present invention including those leading into a cubby hole, shelf, cabinet, or other structures for storing and organizing footwear.

The case 11, which may be substantially hollow, includes an exterior portion 22 and an inner chamber 14. An air inlet 15 is disposed at the exterior portion of the case 11 in order to allow air into the inner chamber 14. A compressor 16 is disposed within the inner chamber 14 of the case 11 proximate to the air inlet 15 in order to pressurize the inner chamber 14 by forcing outside air through the air inlet 15 when desired. The compressor 16 is a fan in a preferred embodiment of the present invention; however, it can be seen by anyone of ordinary skill in the art that other devices for compression may be utilized in addition to fans.

A sanitizer generator 17 is disposed within the inner chamber 14 of the case 11 proximate to the compressor 16 for generating ozone for introduction into an article of footwear ‘S’. Ozone is the second most potent sanitizer known to man and is a preferred sanitizer in the present invention. Ozone does not cover up odors with perfumes. It actually destroys the odors, fungi, bacteria, and mold at the molecular level. The constant flow of air mixed with ozone accomplishes three objectives (removes moisture, sanitizes and deodorizes). The ozone kills existing bacteria, fungi, mold and helps prevent odors, athlete's foot, toenail fungus, and other problem growths. Additional sanitizing, deodorizing, and fungicidal agents may be introduced into the footwear by means of an optional pressurized source.

A rheostat 18 is electrically connected to the generator 17 so as to allow for the adjustment of ozone output or concentration. A programable timer/processor 19 could be incorporated to automatically operate the generator 17. A button 20 is disposed on the exterior portion 22 of the hollow case 11, to allow for a sanitizing/deodorizing cycle to be started when the button 20 is depressed.

The conduits 12 are disposed about the exterior portion 22 of the hollow case 11 such that the conduits 12 may be inserted into an article of footwear ‘S’. Generally, the conduits 12 proceed outwardly from the exterior surface 22 of the hollow case 11 such that an angle θ is formed between the hollow case 11 and the conduits 12. In a preferred embodiment of the present invention, the angle θ is an acute angle so as to facilitate the hanging of the article of footwear ‘S’. However, any angle that will adequately secure the article of footwear ‘S’ to the conduits 12 may be employed.

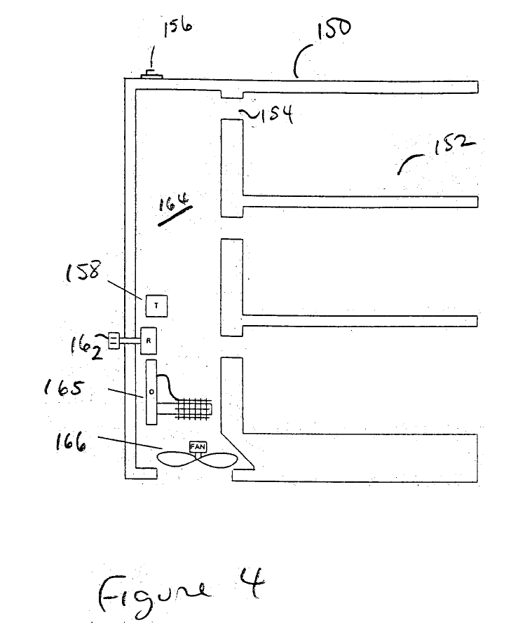

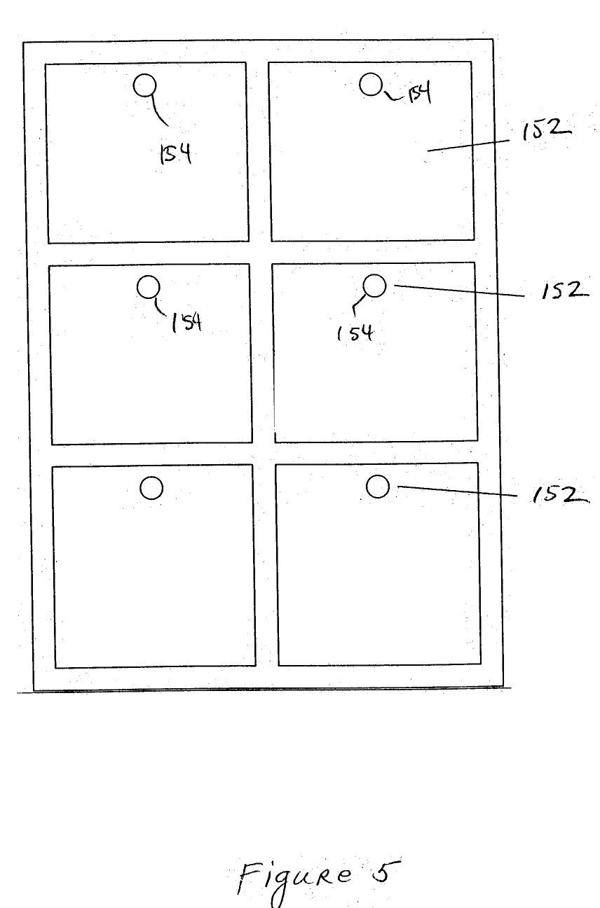

This angle may not be required in an embodiment such as shown in FIGS. 4 and 5 where the conduit provides a flow path into a cubbyhole, shelf, cabinet, or other structure for storing and organizing footwear. The conduits have open ends 13 at one end which are in gaseous communication with the inner chamber 14 of the hollow case 11 to allow a sanitizer within the inner chamber 14 to flow through the conduits 12 and out of the open ends 13 into the articles of footwear ‘S’.

With reference now to FIG. 1, a typical sanitizing/deodorizing cycle will now be described. The article of footwear ‘S’ is placed upon one of the conduits 12. The button 20 may then be depressed in order to start the sanitizing/deodorizing cycle. For example, the button 20, when depressed, may activate the timer 19. Once activated, the timer 19 will begin the sanitizing cycle by causing the generator 17 to begin producing ozone. In a preferred embodiment of the present invention, the generator 17 will produce ozone as the sanitizer/deodorizer, however, it can be readily seen by one of ordinary skill in the art that any sanitizing, deodorizing, or fungicidal agents may be employed. The compressor 16 will likewise be started during the sanitizing/deodorizing cycle in order to pressurize the inner chamber 14 of the hollow case 11. This pressurization will force the sanitizer/deodorizer to travel through the conduit 12 and escape through the open end 13 of conduit 12 into the article of footwear ‘S’. Each conduit being of equal dimension will facilitate equal flow to the footwear. Before, or during, the cycle, the rheostat 18 may be adjusted in order to increase or decrease the amount or concentration of the sanitizer/deodorizer that is produced by the generator 17 for introduction into the article of footwear ‘S’. Alternatively, the programmable timer/processor 19 may be programmed to turn the generator 17 on and off at various times without the interaction of a person aside from setting the program.

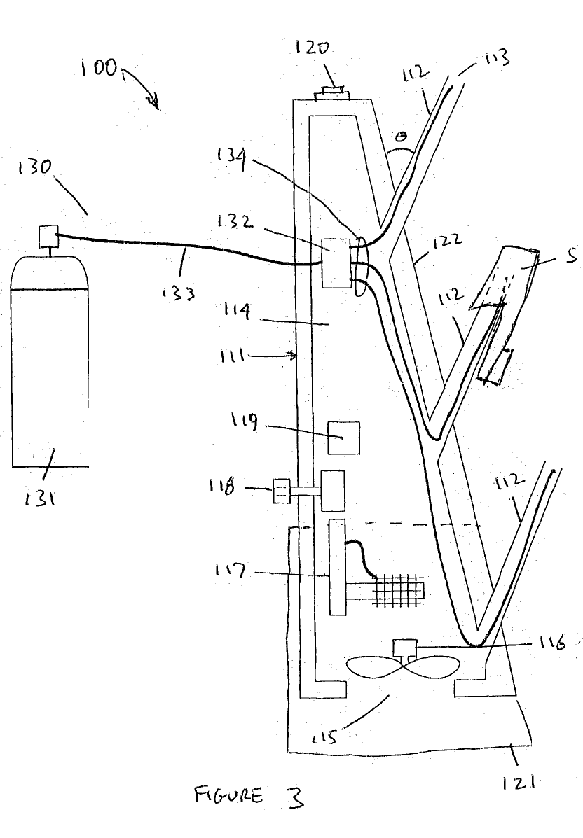

Referring now to FIG. 3, an alternative footwear organizer sanitizer 100 is shown. The footwear organizer sanitizer 100 includes a hollow case 111, conduits 112, and removable floor stands 121.

The hollow case 111 includes an exterior portion 122 and an inner chamber 114. An air inlet 115 is disposed at the exterior of the hollow case 111 in order to allow air into the inner chamber 114. A compressor 116 is disposed within the inner chamber 114 of the hollow case 111 proximate to the air inlet 115 in order to pressurize the inner chamber 114 by forcing outside air through the inlet 115 when desired. The compressor 116 is a fan in a preferred embodiment of the present invention; however, it can be seen by anyone of ordinary skill in the art that other devices for compression may be utilized in addition to fans. A sanitizer generator 117 is disposed within the inner chamber 114 of the hollow case 111 proximate to the compressor 116 for generating a sanitizer/deodorizer such as ozone for introduction into an article of footwear ‘S’.

A rheostat 118 is electrically connected to the programmable timer/processor and the generator 117 so as to allow for the adjustment of sanitizer/deodorizer output or concentration. A programmable timer/processor 119 could be incorporated to automatically operate the generator. A button 120 is disposed on the exterior portion 122 of the hollow case 111, to allow for a sanitizing/deodorizing cycle to be started when the button 120 is depressed.

The equally dimensioned conduits 112 are disposed about the exterior portion 122 of the hollow case 111 such that the conduits 112 may be inserted into an article of footwear ‘S’. Generally, the conduits 112 proceed outwardly from the exterior surface 122 of the hollow case 111 such that an angle θ is formed between the hollow case 111 and the conduits 112. In a preferred embodiment of the present invention, the angle θ is an acute angle so as to facilitate the hanging of the article of footwear ‘S’. However, any angle that will adequately secure the article of footwear ‘S’ to the conduits 112 may be employed. The conduits have open ends 113 at one end which are in gaseous communication with the inner chamber 114 of the hollow case 111 to allow a sanitizer/deodorizer within the inner chamber 114 to flow through the conduits 112 and out through the open ends 113 into the articles of footwear ‘S’.

Additionally, the footwear organizer sanitizer deodorizer 100 includes a supplementary sanitizer, deodorizer, or fungicide source 130. This supplementary source 130 includes a pressurized canister 131, a valve 132, an inlet tube 133, and outlet tubes 134.

The canister 131 is situated outside of the hollow case 111, but proximate to it. The inlet tube 133 is connected to the canister on one end and to the valve 132 on the other end so as to allow the contents contained in the canister 131 to flow through the inlet tube 133 into the valve 132. The outlet tubes 134 are connected to the valve 132 at one end in the inner chamber 114 of the hollow case 111, and continue through the conduits 112 to the open ends 113. In this manner, the supplemental sanitizer 130 can introduce a sanitizing agent into the articles of footwear ‘S’ during the sanitizing cycle. As an alternative to a supplementary sanitizer, the canister 131 may contain sanitizing, deodorizing, or fungicidal agents for introduction into the article of footwear ‘S’.

The programmable timer/processor 119 in the footwear organizer sanitizer deodorizer 100 may be programmed so that sanitizer from the sanitizer generator 117 and supplemental sanitizer, deodorizer, or fungicide from the supplementary source 131 are introduced into the article of footwear ‘S’ either separate from each other or at the same time. The programmable timer/processor 119 in this configuration will be operatively connected to the valve 132 of the supplementary sanitizer, deodorizer, or fungicied source 130 to turn the valve 132 on or off.

Referring to FIGS. 4 and 5, an alternative embodiment of the present invention which is shown and described in the context of a cubbyhole configuration. FIG. 4 is a cross section view which illustrates the basic elements. As shown, the embodiment comprises a casing structure 150 which incorporates cubbyhole sections 152 which can support and hold footwear. The system includes a plurality of flow paths or conduits 154 for each cubbyhole. As with the earlier embodiments, each conduit 154 is designed with an equal dimension to facilitate equal flow as shown in FIG. 5. A flow path from a pressurized chamber 164 is positioned for each cubbyhole.

A quick start button 156, which is similar to button 20, is used to manually start the flow of ozone flow for a predetermined period. Alternatively, a timer unit 158 can be programmed to run the ozone generator 160 for predetermined periods of time during the day. As in the previous embodiment, the rheostat 162 may be provided for the adjustment of ozone output or concentration. The ozone generator 165 is similarly mounted inside pressurized chamber 164. A 166 fan pressurizes the chamber when the ozone generator is turned on.

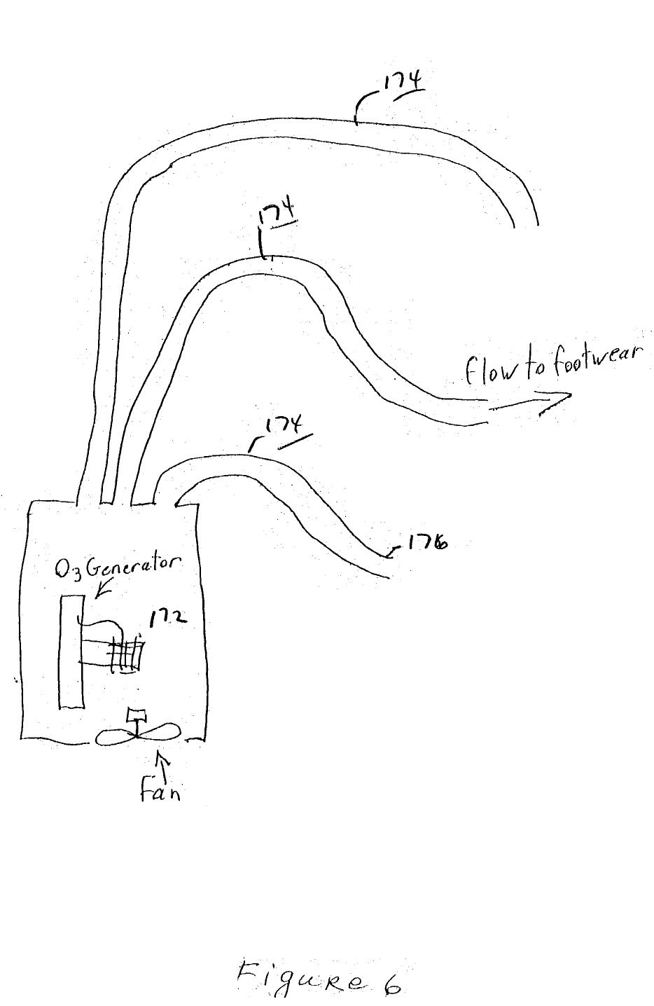

In yet a further embodiment of FIG. 6, the ozone generator 172 is in communication with three flexible conduits 174, all having different lengths. More ozone will flow out of the shorter conduit 176.

In view of the foregoing disclosure, some of the advantages of the present invention can be seen. For instance, a novel footwear organizer sanitizer deodorizer is disclosed. This footwear organizer sanitizer deodorizer allows for a user to determine the amount of sanitizer deodorizer to be introduced into the footwear to sanitize and deodorize them. Furthermore, the footwear organizer sanitizer deodorizer allows for a supplemental sanitizing, deodorizing, or fungicidal agent to be introduced into footwear.

While the preferred embodiments of the present invention have been described and illustrated, modifications may be made by one of ordinary skill in the art without departing from the scope and spirit of the invention as defined in the appended claims. For example, in a preferred embodiment of the present invention, the hollow cases 11, 111 and 150, respectively, are formed of wood. However, other materials may be used such as molded plastic, metal, or composite materials. Additionally, as discussed, in a preferred embodiment of the present invention the sanitizer is ozone, but any adequate sanitizer, deodorizer, or fungicide known to one of ordinary skill in the art may be employed.

The true nature and scope of the present invention is to be determined with reference to the attached claims.

1. A sanitizing footwear organizer comprising:
a case having an exterior portion and an inner chamber;
at least one conduit, having an open end, situated in the case, said case supporting an article of footwear thereon, wherein the open end of the at least one conduit is in gaseous communication with the inner chamber of the hollow case; and
a sanitizer disposed within the inner chamber of the hollow case for release into the article of footwear through the open end of the at least one conduit.

2. The sanitizing footwear organizer of claim 1, further comprising a removable floor stand mounted on opposite ends of the exterior portion of the case.

3. The sanitizing footwear organizer of claim 1, wherein the sanitizer is Ozone.

4. The sanitizing footwear organizer of claim 1, further comprising an inlet on the exterior portion of the case.

5. The sanitizing footwear organizer of claim 4, further comprising a compressor disposed within the inner chamber of the case proximate to the inlet.

6. The sanitizing footwear organizer of claim 5, further comprising a generator disposed within the inner chamber of the case, for generating the sanitizer.

7. The sanitizing footwear organizer of claim 6, further comprising a rheostat in electrical communication with the generator for adjusting the output or concentration of the sanitizer.

8. The sanitizing footwear organizer of claim 1, further comprising a button disposed on the exterior portion of the hollow case for operating the timer.

9. The sanitizing footwear organizer of claim 1, further comprising an pressurized source of sanitizer which may be internal or external.

10. The sanitizing footwear organizer of claim 1, further comprising a plurality of conduits having open ends, and mounted on the exterior of the case for supporting a plurality of articles of footwear on, wherein the open ends of the plurality of conduits are in gaseous communication with the inner chamber of the hollow case.

11. The sanitizing footwear organizer of claim 10 wherein the plurality of conduits each comprise a flexible tube.

12. A sanitizing footwear organizer comprising:
a hollow case, having an exterior portion and an inner chamber;
a plurality of conduits, substantially of equal dimensions, each having an open end, mounted on the exterior of the hollow case for hanging a plurality of articles of footwear on, wherein the open ends of the plurality of conduits are in gaseous communication with the inner chamber of the hollow case;
a sanitizer disposed within the inner chamber of the hollow case for release into the article of footwear through the open end of the at least one conduit;
a generator disposed within the inner chamber of the hollow case, for generating the sanitizer;
a timer, mounted within the inner chamber of the hollow case, operatively connected to the generator to activate and deactivate the generation of sanitizer;
a floor stand mounted on opposite ends of the exterior portion of the hollow case;
an inlet on the exterior portion of the hollow case;
a compressor disposed within the inner chamber of the hollow case proximate to the inlet;
a generator disposed within the inner chamber of the hollow case, for generating the sanitizer;
a rheostat in electrical communication with the generator for adjusting the output or concentration of the sanitizer; and
a button disposed on the exterior portion of the hollow case for operating the timer.

13. A sanitizing footwear organizer comprising:
a hollow case, having an exterior portion and an inner chamber;
a plurality of conduits, of substantial equal dimensions, each having an open end, mounted on the exterior of the hollow case for hanging a plurality of articles of footwear on, wherein the open ends of the plurality of conduits are in gaseous communication with the inner chamber of the hollow case;
a sanitizer disposed within the inner chamber of the hollow case for release into the article of footwear through the open end of the at least one conduit;
a generator disposed within the inner chamber of the hollow case, for generating the sanitizer;
a timer, mounted within the inner chamber of the hollow case, operatively connected to the generator to activate and deactivate the generation of sanitizer;
a floor stand mounted on opposite ends of the exterior portion of the hollow case;
an inlet on the exterior portion of the hollow case;
a compressor disposed within the inner chamber of the hollow case proximate to the inlet;
a rheostat in electrical communication with the generator for adjusting the output or concentration of the sanitizer;
a button disposed on the exterior portion of the hollow case for operating the timer; and
a pressurized source of sanitizer.

14. The footwear organizer sanitizer of claim 13, further comprising a valve in gaseous communication with the pressurized source of sanitizer for controlling the flow of sanitizer from the pressurized source into the article of footwear.

15. The footwear organizer sanitizer of claim 14, wherein the timer is operatively connected to the valve in order to regulate the flow of sanitizer from the pressurized source by activating or deactivating the valve.

16. The footwear organizer sanitizer of claim 15, wherein the timer activates the generator and the valve at the same time.

17. The footwear organizer sanitizer of claim 15, wherein the timer activates the generator and the valve at different times.

18. A sanitizing deodorizing footwear organizer comprising:
a hollow case, having an exterior portion and an inner chamber;
a plurality of conduits, each having an open end, mounted on the exterior of the hollow case for hanging a plurality of articles of footwear on, wherein the open ends of the plurality of conduits are in gaseous communication with the inner chamber of the hollow case;
a sanitizer disposed within the inner chamber of the hollow case for release into the article of footwear through the open end of the at least one conduit;
a generator disposed within the inner chamber of the hollow case, for generating the sanitizer/deodorizer:
a programmable timer/processor, operatively connected to the generator to activate and deactivate the generation of sanitizer/deodorizer;
a removable floor stand mounted on opposite ends of the exterior portion of the hollow case;
an inlet on the exterior portion of the hollow case;
a compressor disposed within the inner chamber of the hollow case proximate to the air inlet;
a generator disposed within the inner chamber of the hollow case, for generating the sanitizer/deodorizer;
a rheostat in electrical communication with the programmable timer/processor and the generator for adjusting the output or concentration of the sanitizer/deodorizer; and
a button disposed on the exterior portion of the hollow case for operating the programmable timer/processor.
